(19) United States
(12) Patent Application Publication
(10) Pub. No.: US 2017/0236107 A1
(43) Pub. Date: Aug. 17, 2017

(54) Automated Teller Machine and Related Method

(71) Applicant: MASTERCARD INTERNATIONAL INCORPORATED, Purchase, NY (US)

(72) Inventor: Ankur Arora, New Delhi (IN)

(21) Appl. No.: 15/429,543

(22) Filed: Feb. 10, 2017

(30) Foreign Application Priority Data
Feb. 11, 2016 (IN) 201611004878

(51) Int. Cl. G06Q 20/10; G06Q 30/02; G07F 19/00

(52) U.S. Cl. CPC G06Q 20/1085; G07F 19/203; G07F 19/206; G06Q 30/0226; G06Q 30/0255

(57) ABSTRACT

An automated teller machine and a method thereof comprising a reading unit configured to receive identification data from an electronic payment device; a personalization unit configured to retrieve predefined details linked to said identification data, access one or more media items and determine a score for at least one media items, a user interface unit configured to receive input data from a user and display one or more selected media items; and a cash dispenser for dispensing a user-selected amount of currency; wherein the personalization unit is configured to select and play back to the user, via the user interface unit, one or more personalized media items based on said predefined details and/or score.

### CROSS-REFERENCE TO RELATED APPLICATION

This application claims the benefit of and priority to Indian Patent Application No. 201611004878, filed Feb. 11, 2016. The entire disclosure of the above application is incorporated herein by reference.

### FIELD

The field of the present disclosure pertains to a machine and mechanism for dispensing cash, and particularly, to provide a more efficient technique, a personalized experience as well as incentives while dispensing cash.

### BACKGROUND

This section provides background information related to the present disclosure which is not necessarily prior art.

Automated Teller Machines or ATMs are machines installed at various locations by a particular bank. Their main function is to dispense cash besides other facilities, such as providing information and certain other services. They are in operation 24×7 and do not require any manual intervention besides that of the user. They conventionally operate by using a payment card and provide the same services in a generic manner to all users.

Generally, users who have an account in a particular bank, or a debit card of a certain bank, make use of an ATM of that particular bank. However that is not always convenient as, for example, an ATM may not be located in a location that is accessible and convenient for a user at the time he needs to use it. For this reason, he has an option of using the nearest ATM which may belong to another bank. However, this service comes with a surcharge that is levied on the user.

Similarly, for banks also, ATMs are a cost center. This is because banks invest large amounts of money into building and maintaining these ATMs and their associated infrastructure. Installation and upkeep of the machine, as well as other requirements regarding the center where it is installed, involve a lot of expenditure. For this purpose, a part of this cost is passed on to the customers of other banks who use the machine by levying a small surcharge when they withdraw cash.

### SUMMARY

This section provides a general summary of the disclosure, and is not a comprehensive disclosure of its full scope or all of its features. Aspects and embodiments of the disclosure are also set out in the accompanying claims.

Embodiments of the present disclosure improve user experience as well as removing the complexities and inefficiencies for both the bank and the user. The user experience is improved since (s)he gets an economic benefit of not having to pay any surcharge. Also viewing an informative media clipping or image or advertisement or getting a good offer on a product or service is beneficial to the user. Similarly inefficiencies involving an extra surcharge or having to take extra fees from the user and adding it to their account can be removed as an extra transaction of the bank, thereby reducing complexities.

In fact, the present disclosure converts ATMs from cost centers to potential profit making centers. This is possible by having an option to remove the surcharge applicable to the user. The present disclosure does so by primarily giving the user an option of viewing a media item in relation to a merchant selected based on user personalization criteria. The bank, in turn, is at an advantage as well since this merchant provides certain benefits to the bank for displaying their media item. Also at an advantage is the merchant who is provided a targeted audience through the ATM.

### DRAWINGS

The drawings/figures described herein are for illustrative purposes only of selected embodiments and not all possible implementations, and are not intended to limit the scope of the present disclosure.

The detailed description is described with reference to the accompanying figures. In the figures, the left-most digit(s) of a reference number identifies the figure in which the reference number first appears. The same numbers are used throughout the drawings to reference like features and components.

FIG. 1 shows a schematic diagram illustrating an example multi-party transaction payment system for enabling ordinary payment transactions in which merchants and card issuers do not need to have a one-to-one special relationship.

FIG. 2 shows a block diagram depicting an overall system architecture diagram of the ATM and external servers.

FIG. 3 shows a flow diagram depicting the process conducted at the ATM communicating with various other external units.

### DETAILED DESCRIPTION

Exemplary embodiments now will be described with reference to the accompanying drawings. The description and specific examples included herein are intended for purposes of illustration only and are not intended to limit the scope of the present disclosure. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

In addition, all logical units described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

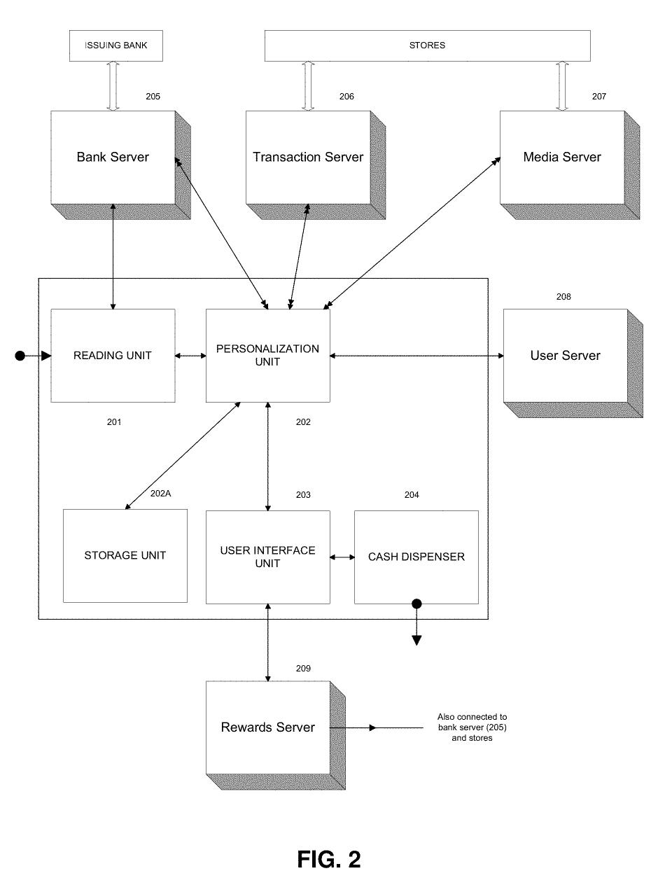

The ATM in the present disclosure has a surcharge removal option provided to the user based on their viewing of a media item, for example, a 15 second video or advertisement. This media item is tailored for that user based on criteria, for example, his preferences, or the services and products available close to the location of that ATM, or legacy data which reflects the items or services he most frequently spends on. An exemplary ATM 200 is shown in FIG. 2, and will be described in more detail below.

For example, travel or restaurant related advertisements or media items can be shown to a frequent traveler or similarly to a user whose spending history depicts frequent transactions at gourmet joints. In a preferred embodiment, these can also be tailored according to the merchants of choice of the user which once again can be determined from legacy data or other means which may include user data gathered by the bank through other means. In yet another embodiment, a user's spending history and/or location data from the ATM 200 is used to select personalized advertisements or media items to display to the user at the ATM.

In a preferred embodiment, the advertisement or media item can be selected based on computation of a relevance score determined from the data gathered in relation to predefined criteria. Preferably the relevance score can be calculated as follows:

Score=w1*purchase sequence probability in a category+W2*loyalty to the advertisement merchant+w3*repeat purchases+w4*rating factor of the merchant,
in which w1, w2, w3 and w4 are weights given to each of the criteria considered.

Furthermore, the data values from purchase sequence probability, loyalty to the advertisement merchant, repeat purchases and rating factor of the merchant may not be on the same scale. For example, purchase probability might have a scale with value in the range 0 to 1, while repeat purchases might as an integer take values in the range 1 to 100, thus, a pure numerical addition might be misleading. Instead, more generally, for each of the variables, the respective data values are normalized by converting each to a common scale, and then generating the composite score as a combination of the converted scores. The normalization of the repeat purchase variable may be done in the following way, for example:

Normalized Repeat Purchase=(Repeat Purchase−Mean(Repeat Purchase))/(Standard Deviation(Repeat Purchase),
i.e. a z-score may be computed for the repeat purchase variable. Similarly, a z-score may be computed for each other variable so as to bring them to the same scale (e.g., so that the variables lie on the interval [0, 1]).

Equal weights w1, w2, w3, w4 may be given to each of the values given in Eqn. (1), i.e. each may be given a relative weight of 0.25. As the user clicks on or otherwise interacts with the advertisement shown on the display of ATM 200, these weights may be updated to reflect the preference of the customer for each of these variables. For example, if the customer tends to click on the advertisements of the merchants with which he is loyal and not based on the amount of discount offered by the merchant, then we assign a higher weight to the variable repeat purchase and a lower weight to merchant rating. The amount by which to adjust the weights may be determined according to techniques which are known in the art of machine learning.

In a preferred embodiment, initially equal weights are given to each of the parameters. However, over time, based on the choices which the user makes, such as purchasing products in the displayed media item or advertisement, these weights can be accordingly changed based on the response received by the advertisement or media item displayed. These weights may be dynamically updated based on the user's response to the advertisement.

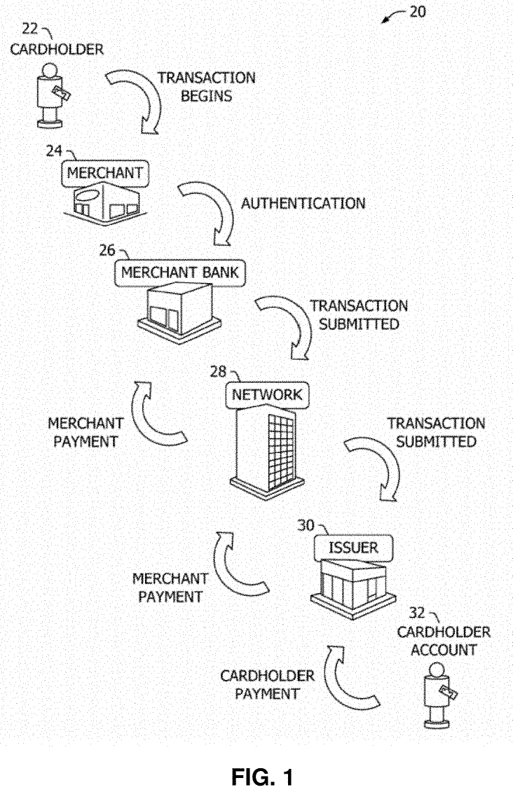

Criteria, such as probability of purchase in a category, can be considered. This can be based on a past purchase sequence pattern of the customer. The past purchase sequence pattern can be determined based on legacy data or past historical purchase data, which may be generated during the course of transactions carried out over a payment network, such as that depicted in FIG. 1 (to be described in further detail below). Another criterion, such as merchant rating, can be considered. The merchant rating is a qualitative score which, for example, can be given by a third party, or by multiple third parties (e.g., via a social media platform). It can range, for example, between 0 to 100% and be calculated based on current discounts or cashback offers made available by the merchant. This way merchants are allowed to improve their ranking by giving additional discount offers resulting in a higher score. Repeat purchases can be determined based on how many times the user has had transactions with that merchant based on the spending history.

In another preferred embodiment, the user is incentivized to respond to a displayed advertisement or media item by providing extra points or discounts on shopping at the advertised location, for example, within a certain number of days. In yet another embodiment, this incentive can also be provided based on just showing the card or electronic payment device used at the ATM and/or entering a portion of the card number as a coupon code at the shop. In yet another preferred embodiment, the receipt or coupon can be printed at the ATM itself with relevant information. For example, the rewards information can be embedded in a linear or matrix bar code (such as a QR code) on the receipt. This information can be read at the store where it can be reclaimed for discounts or other such benefits.

The disclosure, by using the aforementioned mechanism, can also be used for determining the efficacy of the advertisement, since a media server (207) in communication with the ATM can store a coupon code for each instance of a displayed media item or advertisement. When the coupon is redeemed at the advertised location, the coupon code may be transmitted to the media server (207) in order to confirm the redemption. As such, the media server (207) can monitor the number of redeemed coupons as a percentage of the number of awarded coupons, as one measure of effectiveness of the advertisement. This can further be incentivized by the bank by asking for a certain percentage of the purchase or a fixed value per transaction made by the customer going to that shop based on seeing the advertisement.

FIG. 1 is a schematic diagram illustrating an example multi-party transaction payment system 20 for enabling ordinary payment transactions in which merchants 24 and card issuers 30 do not need to have a one-to-one special relationship. Embodiments described herein may relate to a transaction system, such as the payment network operated by MasterCard International Incorporated, the assignee of the present disclosure. Such a network is comprised, in part, of a set of proprietary communications standards and protocols for the exchange of financial transaction data and the settlement of funds between financial institutions that are members of the payment network.

In a typical payment system, a financial institution called the “issuer” 30 issues a payment card, such as a credit card, debit card, electronic check, prepaid card, paper check, mobile phone with access to a payment account, or any other form of payment, to a user 22, who uses the payment card to tender payment for a purchase from a merchant 24. To accept payment with the payment card, merchant 24 must normally establish an account with a financial institution that is part of the financial payment system. This financial institution is usually called the “merchant bank,” the “acquiring bank,” or the “acquirer.” When user 22 tenders payment for a purchase with a payment card, merchant 24 requests authorization from a merchant bank 26 for the amount of the purchase. The request may be performed over the telephone, but is usually performed through the use of a point-of-sale (POS) terminal, which reads user's 22 account information from a magnetic stripe, a chip, embossed characters, or other device on the payment card that may be manually inputted into the POS terminal, and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using a payment network 28, computers of merchant bank 26 or merchant processor will communicate with computers of an issuer bank 30 to determine whether the payment transaction should be authorized. This may include a number of factors such as, whether user's 22 account 32 is in good standing, and whether the purchase is covered by user's 22 available credit line. If the request is accepted, an authorization code is issued to merchant 24.

When a request for authorization is accepted, the available credit line of user's 22 account 32 is decreased. In some cases, a charge for a payment transaction may not be posted, i.e., “captured” immediately to user's 22 account 32, whereas in other cases, especially with respect to at least some debit card transactions, a charge may be posted or captured at the time of the transaction. In some cases, when merchant 24 ships or delivers the goods or services, merchant 24 captures the transaction by, for example, appropriate data entry procedures on the POS terminal. This may include bundling of approved transactions daily for standard retail purchases. If user 22 cancels a transaction before it is captured, a “void” is generated. If user 22 returns goods after the transaction has been captured, a “credit” is generated. Payment network 28 and/or issuer bank 30 stores the payment card information, such as a type of merchant, amount of purchase, date of purchase, in a database.

For debit card transactions, when a request for a PIN authorization is approved by the issuer, the consumer's account is decreased. Normally, a charge is posted immediately to a consumer's account. The issuer 30 then transmits the approval to the merchant bank 26 via the payment network 28, with ultimately the merchant 24 being notified for distribution of goods/services, or information or cash in the case of an ATM.

After a purchase has been made, a clearing process occurs to transfer additional transaction data related to the purchase among the parties to the transaction, such as merchant bank 26, payment network 28, and issuer bank 30. More specifically, during and/or after the clearing process, additional data, such as a time of purchase, a merchant name, a type of merchant, purchase information, user account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when user 22 purchases travel, such as airfare, a hotel stay, and/or a rental car, at least partial itinerary information is transmitted during the clearance process as transaction data. When payment network 28 receives the itinerary information, payment network 28 routes the itinerary information a database.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and payment network 28, and then between payment network 28 and merchant bank 26, and then between merchant bank 26 and merchant 24.

FIG. 2 shows a block diagram depicting an overall system architecture diagram of the ATM 200 and external servers with which the ATM 200 is communicatively coupled. In a preferred embodiment, a bank server (205) is configured to store the details of each payment device it issues along with the associated bank account details. The bank server (205) is operatively connected to the reading unit (201) of the ATM 200 by a communications link in order to provide the bank name and account information upon request. The user interface unit (203) is also in a preferred embodiment operatively connected to the bank server (205) so that the bank can be intimated that no surcharge is to be applied for this transaction if the user has agreed to watch the media item. Once the amount has been dispensed, the bank server (205) is configured to receive appropriate details from the user interface unit (203) to update the details accordingly in the relevant account.

In another preferred embodiment, a transaction server (206) is configured to store the transaction history of each payment device. Preferably, it is configured to keep a record of all transactions against a specific payment device including the date, time, amount, and merchant identifier for each transaction. The personalization unit (202) is operatively connected to the transaction server (206) and is configured to communicate with it to retrieve the transaction history and legacy data of the user. In another embodiment, the personalization unit (202) is configured to directly retrieve these from the bank server (205) which is configured to store these details in place of the transaction server (206).

In yet another preferred embodiment, a media server (207) is configured to store one or more media items along with their details. Each video or image stored is preferably associated with a particular merchant ID, merchant category and/or industry type among other criteria. The media server (207) is operatively connected to the personalization unit (202) of the ATM. In another embodiment, the media items are stored within a storage unit (202A) within the ATM along with these details instead of the media server (207) and the personalization unit (202) is operatively connected to this storage unit (202A). In a preferred embodiment, the media server (207) or storage unit (202A) can be accessed by the store to add or update their media items or advertisements as well as add or update their offers in order to improve their merchant score.

In another preferred embodiment, a user server (208) is configured to store user details and preferences of a user attached to a particular payment device. The user preferences may alternatively, in another embodiment, be stored at the transaction server (206) itself or in another embodiment at the bank server (205). The personalization unit (202) is configured to communicate with the appropriate server (205, 206, 208) to retrieve the preferences of the user associated with the payment device.

In yet another preferred embodiment, a rewards server (209) is configured to store details of the coupons, receipts and rewards issued to or redeemed by a user of a particular payment device, such as the receipt number or unique code, and the dates of issuance and redemption. These details may alternatively, in another embodiment, be stored at the bank server (205) itself or at the transaction server (206) or at the media server (207). The user interface unit (203) is configured to communicate with the appropriate server (205, 206, 207) to retrieve and update the rewards information of the user attached to the payment device. This information can then be accessed at the relevant store from this server (205, 206, 207) to provide discounts and other such benefits and the information at the server (205, 206, 207) can accordingly be updated after such a transaction. This information can also be accessed at the bank server (205) to provide cash back offers into the account of the user. This information can also be accessed at the ATM to check rewards information and/or the coupon code generated by the ATM for the user.

FIG. 2 depicts an improved automated teller machine 200 comprising a reading unit (201) which is configured to receive identification data from an electronic payment device; a personalization unit (202) which is configured to retrieve predefined details linked to said identification data, access one or more media items and determine a score for at least one media; a user interface unit (203) configured to receive input data from a user and display one or more selected media items; and a cash dispenser (204) for dispensing a user-selected amount of currency wherein the personalization unit (202) is configured to select and playback to the user, via the user interface unit (203), the one or more personalized media items based on the predefined details and/or score.

The user uses/accesses the ATM through the reading unit (201) by inserting or tapping his electronic payment device, which may be a payment card, or another payment device which is not in the form of a card, such as a smartphone, or other device able to be read in contactless fashion. The reading unit (201) is configured to read the relevant details from this card and, accordingly, identify the relevant bank and the account number, among other details. It is also configured to access the bank server (205) of the identified bank for other predefined details, such as account information and verification data. The reading unit (201) may comprise a magnetic stripe reader, an EMV card reader or an NFC reader, for example. In a preferred embodiment, the user interface unit (203) may be configured to receive additional data for authentication or verification purposes, such as a PIN or biometric information. Existing communication techniques can be used to procure this information as well as validation criteria.

The personalization unit (202) is operatively coupled to the reading unit (201) and is configured to access either the bank server (205) or the transaction server (206) to retrieve relevant transaction data. This transaction data preferably includes comprehensive legacy data. In an embodiment, the personalization unit (202) is then configured to retrieve user preference details from either the bank server (205), transaction server (206) or user server (208). If is further configured to access one or more media items, preferably, from the media server (207) or, alternatively, from the storage unit (202A) within the ATM along with their details such including merchant details.

The personalization unit (202) is also configured to compute a score for each accessed media item based on various factors, such as the merchant and/or retrieved transaction history and/or user preferences and/or ATM location data and/or some other predefined criteria. In a preferred embodiment, the score is computed as follows:

Score=w1*purchase sequence probability in a category+W2*loyalty to the advertisement merchant+w3*repeat purchases+w4*rating factor of the merchant,
in which w1, w2, w3 and w4 are weights given to the respective criteria considered.

The loyalty of the user to a certain merchant can be determined by retrieving the loyalty points that the user has with that merchant from the media server (207). The score for a particular media item for a user can be dynamically updated based on the current merchant rating and/or user's transaction history. In a preferred embodiment, the personalization unit (202) is configured to compute the score in the offline mode, i.e. not while a transaction is happening at the ATM.

In a preferred embodiment, the personalization unit (202) is then configured to select one or more highest-scoring videos or images (for example, one of the top 5 highest-scoring videos or images, or one of the videos or images which exceeds a predetermined score threshold). In another embodiment, these are chosen at random or in yet another embodiment are chosen based on whether they exceed a certain threshold of one or more deciding factors.

On selection, the user interface unit (203) is configured to display the selected item to the user with an option requesting the user for input on whether he wishes to view the selected video or image and apprising him of the fact that viewing it will, in an embodiment, waive the surcharge or in another embodiment, provide the user with reward or loyalty points. In case the user does not agree, the cash dispenser (204) is configured to give out the amount requested. In a preferred embodiment, the user interface unit (203) is also configured to contact the bank server (205) and add a surcharge or levy a fee to the user's bank account.

If, however, the user does agree to view, the user interface unit (203) is configured to display the one or more media items and signal the cash dispenser (204) which is configured to dispense the selected amount of cash. In this case, no surcharge is levied to the user. In a preferred embodiment the loyalty points of the user are increased or in yet another embodiment, the user interface unit (203) is configured to provide a coupon code by displaying or printing it which can be used at a certain merchant for discounts. In a preferred embodiment, the rewards information and/or discount information is updated against that payment device at the relevant server (205, 206, 207) which is operatively connected to the user interface unit (203).

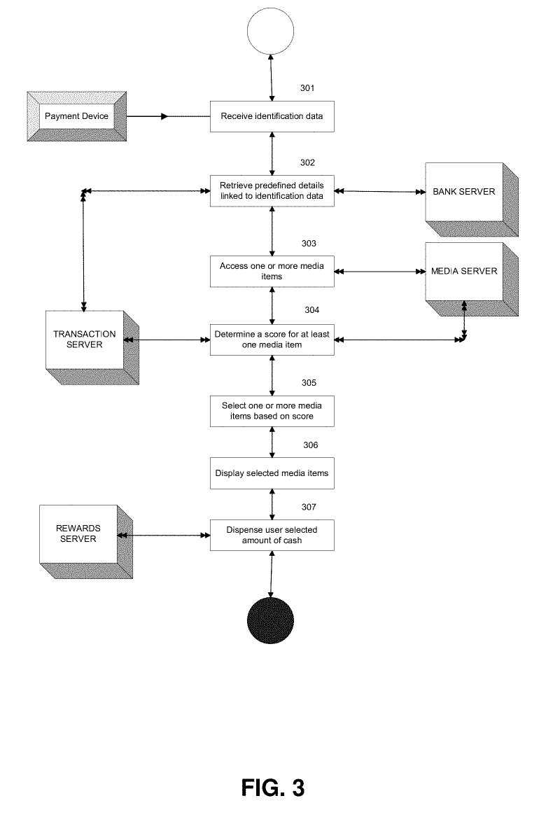

FIG. 3 shows a flow diagram depicting an example of a process conducted at the ATM 200 communicating with various other external units. The operation begins at step 301 in which the user accesses the ATM by either inserting, tapping or touching the payment device at the ATM. The payment device may be a payment card, or another payment device which is not in the form of a card, such as a smartphone, or other device able to be read in contactless fashion. The relevant details are then read from the device and identification data using which relevant bank and account number among other details are identified in step 301.

In step 302, the bank server (205) of the identified bank is accessed to retrieve other predefined details, such as account information and verification data. In a preferred embodiment, additional data for authentication or verification purposes, such as a PIN or biometric information, may also be asked for and received. Existing communication techniques can be used to procure this information as well as validation criteria. In the same step, either the bank server (205) or the transaction server (206) is accessed to retrieve relevant transaction data. This transaction data preferably includes comprehensive legacy data. In an embodiment, the bank server (205), transaction server (206) or user server (208) is accessed to retrieve user preference details.

Next, in step 303, one or more media items are accessed, preferably, from the media server (207) or alternatively from the storage unit (202A) within the ATM along with their details, such as including merchant details. In step 304, a score is determined for each accessed media item based on various factors such as the merchant and/or retrieved transaction history and/or user preferences and/or ATM location data and/or some other predefined criteria. In a preferred embodiment, the score is determined as follows:

Score=w1*purchase sequence probability in a category+W2*loyalty to the advertisement merchant+w3*repeat purchases+w4*rating factor of the merchant,
in which w1, w2, w3 and w4 are weights given to each of the criteria considered.

The loyalty of the user to a certain merchant can be determined by retrieving the loyalty points that the user has with that merchant from the media server (207). The score for a particular media item for a user can be dynamically updated based on the current merchant rating and/or user's transaction history. In a preferred embodiment, the score is determined in the offline mode, e.g. not while a transaction is happening at the ATM (for example, after the transaction has concluded).

In step 305, one or more highest-scoring media items, videos, images or advertisements are selected. In a preferred embodiment, these are chosen based on the determined score. In another embodiment, these are chosen at random or in yet another embodiment are chosen based on whether they exceed a certain threshold of one or more deciding factors.

On selection, in step 306, the selected media items are displayed to the user with an option requesting the user for input on whether he wishes to view the selected video or image and apprising him of the fact that viewing it will, in an embodiment, waive the surcharge or in another embodiment, provide the user with reward or loyalty points.

In case the user does not agree, in step 305, the amount requested is dispensed in step 307. In a preferred embodiment, the ATM contacts the bank server (205) to add a surcharge or levy a fee to the user's bank account. If, however, the user does agree to view, the ATM displays the one or more media items and dispenses the selected amount of cash, in step 307. In this case, no surcharge is levied to the user. In a preferred embodiment, the loyalty points of the user are increased or in yet another embodiment, a coupon code is provided by displaying or printing it which can be used at a certain merchant for discounts. In a preferred embodiment, the rewards information and/or discount information is updated against that payment device at the relevant server.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

Instructions may also be loaded onto a computer or other programmable data processing apparatus, like a scanner/check scanner, to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of FIGS. 1 to 3 illustrate the architecture, functionality, and operations of some embodiments of methods, systems, and computer program products for time related interaction of a user with a handheld device. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the present disclosure. Although specific terms are employed, they are used in a generic and descriptive sense only and not for purposes of limitation, the scope of the invention being defined by the following claims.

With that said, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An automated teller machine comprising:
a. a reading unit configured to receive identification data from an electronic payment device;
b. a personalization unit configured to retrieve predefined details linked to said identification data, access one or more media items and determine a score for at least one media item;
c. a user interface unit configured to receive input data from a user and display one or more selected media items; and
d. a cash dispenser for dispensing a user-selected amount of currency;
wherein the personalization unit is configured to select and play back to the user, via the user interface unit, one or more personalized media items based on said predefined details and/or score.

2. The automated teller machine as claimed in claim 1, wherein the predefined details comprise prior transactions made using the electronic payment device and/or location data of the machine; and/or
wherein the media item comprises one or more of advertisements and/or images and/or videos.

3. The automated teller machine as claimed in claim 1, wherein the score is calculated as follows:
Score=w1*purchase sequence probability in a category+W2*loyalty to the advertisement merchant+w3*repeat purchases+w4*rating factor of the merchant,
in which w1, w2, w3 and w4 are weights given to each of the criteria considered.

4. (canceled)

5. The automated teller machine as claimed in claim 1, wherein the score for each of the media items is based on the predefined details and/or one or more merchant identifiers and/or one or more merchant categories associated with the media items; and
wherein said score is further based on purchase sequence probability of one or more merchant categories and/or loyalty towards the merchant identifier associated with said media item and/or repeat purchases by the user.

6. (canceled)

7. The automated teller machine as claimed in claim 1, wherein the personalization unit is configured to provide one or more incentives to the user based on a selection received at the user interface unit.

8. The automated teller machine as claimed in claim 7, wherein said incentives comprise points or discounts to the user for purchases at one or more merchants; and/or
wherein the user interface unit is configured to print a coupon bearing information relating to said incentives.

9.-11. (canceled)

12. The automated teller machine as claimed in claim 7, comprising a storage unit operatively connected to the personalization unit and/or to the merchants and/or stores and configured to store one or more media items along with their details.

13. A method for dispensing cash from an automated teller machine comprising the steps of:
a. receiving identification data from an electronic payment device;
b. retrieving predefined details linked to said identification data;
c. accessing one or more media items from a media server or storage unit;
d. determining a score for at least one media item;
e. making a selection from one or more stored media items based on the predefined details;
f. displaying one or more selected media items on receiving input data from a user; and
g. dispensing a user-selected amount of currency;
wherein the selection of the media item is based on said predefined details and/or score.

14. The method for dispensing cash from an automated teller machine as claimed in claim 13, wherein the predefined details comprise prior transactions made using the electronic payment device and/or location data of the machine; and/or
wherein the media item comprises one or more of advertisements and/or images and/or videos.

15. The method for dispensing cash from an automated teller machine as claimed in claim 13, wherein the score is calculated as follows:
Score=w1*purchase sequence probability in a category+W2*loyalty to the advertisement merchant+w3*repeat purchases+w4*rating factor of the merchant,
in which w1, w2, w3 and w4 are weights given to each of the criteria considered.

16. (canceled)

17. The method for dispensing cash from an automated teller machine as claimed in claim 13, wherein the score for each of the media items is based on the predefined details and/or one or more merchant identifiers and/or one or more merchant categories associated with the media items; and
wherein said score is further based on purchase sequence probability of one or more merchant categories and/or loyalty towards the merchant identifier associated with said media item and/or repeat purchases by the user.

18. (canceled)

19. The method for dispensing cash from an automated teller machine as claimed in claim 13, comprising the step of providing one or more incentives to the user based on one or more selections.

20. (canceled)

21. The method for dispensing cash from an automated teller machine as claimed in claim 13, comprising the step of printing a coupon bearing information relating to said incentives.

22. (canceled)

23. (canceled)

24. A system for withdrawing cash, the system comprising:
a. bank server operatively connected to one or more banks and configured to store the details of each payment device it issues along with the associated bank account details; and
b. the automated teller machine as claimed in claim 1.

25. The system as claimed in claim 24, wherein the bank server is operatively connected to the reading unit and/or personalization unit and/or user interface unit; and/or
wherein the bank server is configured to update the details after the transaction at the relevant bank account; and/or
wherein the bank server is configured to receive an indication from the ATM and accordingly send an indication to the relevant bank to not apply any fees or surcharge if the user has agreed to watch the media item.

26. (canceled)

27. (canceled)

28. The system as claimed in claim 24, comprising a transaction server operatively connected to one or more banks and configured to store the transaction history of the payment device;
wherein the transaction server is operatively connected to the personalization unit; and/or wherein the transaction server is a part of the bank server.

29.-31. (canceled)

32. The system as claimed in claim 24, comprising a media server operatively connected to one or more merchants and/or stores and configured to store one or more media items along with their details;
wherein the media server is operatively connected to the personalization unit; and/or wherein each media item is associated with a merchant ID, merchant category, industry type and/or one or more offers.

33.-35. (canceled)

36. The system as claimed in claim 24, comprising a user server operatively connected to the personalization unit and configured to store user details and preferences of a user attached to a payment device;
wherein the user server forms part of the bank server and/or transaction server.

37. (canceled)

38. The system as claimed in claim 24, comprising of a rewards server operatively connected to one or more merchants and/or stores and configured to store details of the coupons, receipts and rewards issued to or redeemed by a payment device.

39. The system as claimed in claim 38, wherein the rewards server is operatively connected to the user interface unit; and/or
wherein the rewards server forms part of the transaction server and/or media server.

40. (canceled)
